(19) United States
(12) Patent Application Publication
(10) Pub. No.: US 2016/0110652 A1
(43) Pub. Date: Apr. 21, 2016

(54) DETERMINING BUILDING OCCUPANCY RATES FROM MULTIPLE DATASETS

(71) Applicant: AT&T Mobility II LLC, Atlanta, GA (US)

(72) Inventors: Sheldon K,. Meredith, Roswell, GA (US); Mark Austin, Roswell, GA (US); Jeremy Fix, Acworth, GA (US)

(21) Appl. No.: 14/518,268

(22) Filed: Oct. 20, 2014

(51) Int. Cl. G06N 7/00

(52) U.S. Cl. CPC G06N 7/005

(57) ABSTRACT

A mechanism is provided for determining occupancy of a building at a time segment. Data points for potential occupants are obtained, which each have a collection data source, a probability of occupancy, an identity to a given potential occupant, and a timestamp. An individual probability is determined by: gathering the data points in time segment requested for the given potential occupant such that the data points gathered only identify the given potential occupant, and averaging each of the probability of occupancy for the data points to obtain the individual probability the given potential occupant was in building during time segment. The individual probabilities are added for the potential occupants during the time segment to obtain a total of the individual probabilities, and divided by an amount N, which is a number of occupants that should be in the building, to obtain a building probability of occupancy for the building.

### BACKGROUND

The present disclosure relates generally to determining building occupancy, and more particularly, to determining building occupancy utilizing multiple datasets.

Techniques for detecting or sensing occupancy in a structure, such as a building, are known for a number of applications. For example, an occupancy sensor device attempts to determine if someone is in a room and is often used in home automation and security systems. Many occupancy sensors that are used for home automation or security systems are based on motion sensors. Motion sensors can be mechanical, for example a simple tripwire, or electronic. Known methods for electronic occupancy detection include acoustical detection and optical detection (including infrared light, visible, laser and radar technology). Motion detectors can process motion-sensor data or employ cameras connected to a computer which stores and manages captured images to be viewed and analyzed later or viewed over a computer network. Examples of motion detection and sensing applications are (a) detection of unauthorized entry, (b) detection of cessation of occupancy of an area to extinguish lighting and (c) detection of a moving object which triggers a camera to record subsequent events. A motion sensor/detector is thus important for electronic security systems, as well as preventing the wasteful illumination of unoccupied spaces.

### BRIEF SUMMARY

Exemplary embodiments include a method for determining occupancy of a building. The method includes receiving a request to determine the occupancy of the building at a time segment in the past and obtaining data points for potential occupants of the building. The data points each have a collection data source, a probability of occupancy in the building, an identity that corresponds to a given potential occupant, and a timestamp. An individual probability is determined that the given potential occupant of the potential occupants is in the building during the time segment by: gathering the data points within the time segment requested for the given potential occupant of the potential occupants such that the data points gathered only identify the given potential occupant, and averaging each of the probability of occupancy for the data points of the given potential occupant to obtain the individual probability that the given potential occupant was in the building during the time segment. The method includes determining individual probabilities for each of the potential occupants during the time segment, in response to determining the individual probabilities for each of the potential occupants during the time segment, adding together the individual probabilities for each of the potential occupants during the time segment to obtain a total of the individual probabilities, and dividing the total of the individual probabilities by an amount N, which is a number of occupants that should be in the building during the time segment, to obtain a building probability of occupancy for the building.

Other exemplary embodiments include an apparatus for determining occupancy of a building. The apparatus includes a processor and memory comprising computer-executable instructions that, when executed by the processor, cause the processor to perform operations. The operations include receiving a request to determine the occupancy of the building at a time segment in the past, and obtaining data points for potential occupants of the building, where the data points each have a collection data source, a probability of occupancy in the building, an identity that corresponds to a given potential occupant, and a timestamp. An individual probability is determined that the given potential occupant of the potential occupants is in the building during the time segment by: gathering the data points within the time segment requested for the given potential occupant of the potential occupants such that the data points gathered only identify the given potential occupant, and averaging each of the probability of occupancy for the data points of the given potential occupant to obtain the individual probability that the given potential occupant was in the building during the time segment. The operations include determining individual probabilities for each of the potential occupants during the time segment, in response to determining the individual probabilities for each of the potential occupants during the time segment, adding together the individual probabilities for each of the potential occupants during the time segment to obtain a total of the individual probabilities, and dividing the total of the individual probabilities by an amount N, which is a number of occupants that should be in the building during the time segment, to obtain a building probability of occupancy for the building.

Other exemplary embodiments include a computer program product, tangibly embodied on a computer readable medium, for determining occupancy of a building, the computer program product including instructions that, when executed by a processor, cause the processor to perform operations. The operations include receiving a request to determine the occupancy of the building at a time segment in the past and obtaining data points for potential occupants of the building. The data points each have a collection data source, a probability of occupancy in the building, an identity that corresponds to a given potential occupant, and a timestamp. An individual probability is determined that the given potential occupant of the potential occupants is in the building during the time segment by: gathering the data points within the time segment requested for the given potential occupant of the potential occupants such that the data points gathered only identify the given potential occupant, and averaging each of the probability of occupancy for the data points of the given potential occupant to obtain the individual probability that the given potential occupant was in the building during the time segment. The operations include determining individual probabilities for each of the potential occupants during the time segment, in response to determining the individual probabilities for each of the potential occupants during the time segment, adding together the individual probabilities for each of the potential occupants during the time segment to obtain a total of the individual probabilities, and dividing the total of the individual probabilities by an amount N, which is a number of occupants that should be in the building during the time segment, to obtain a building probability of occupancy for the building.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF EXEMPLARY EMBODIMENTS

Referring now to the drawings wherein like elements are numbered alike in the several FIGURES:

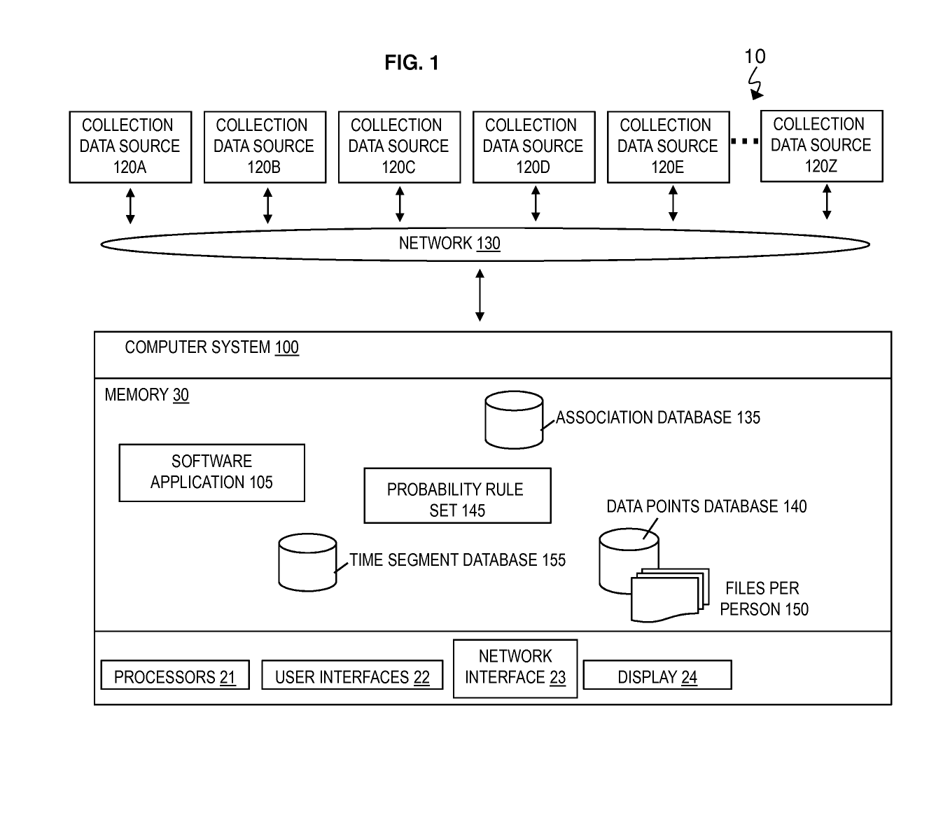

FIG. 1 illustrates a system for determining building occupancy from different collection data sources according to an embodiment;

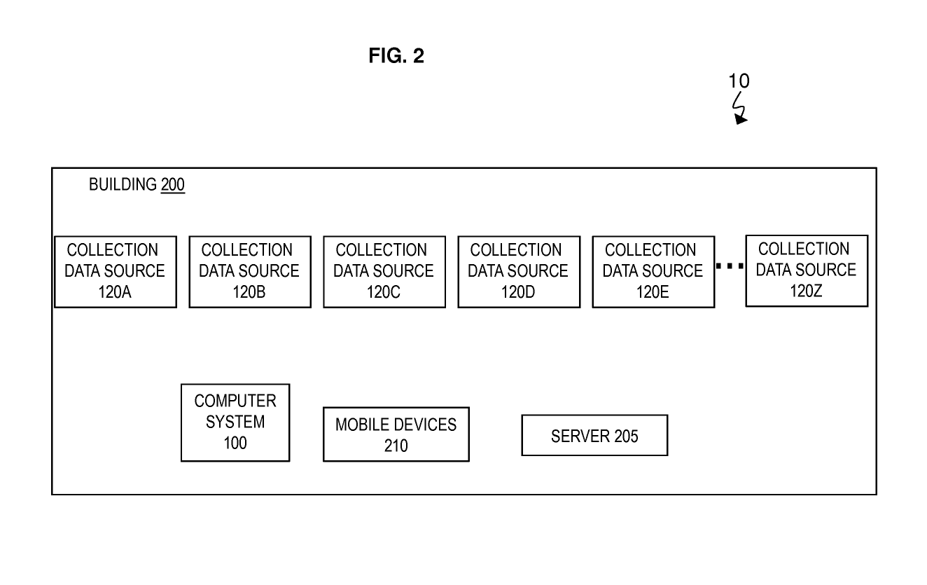

FIG. 2 illustrates a geofenced building for which occupancy is determined according to an embodiment;

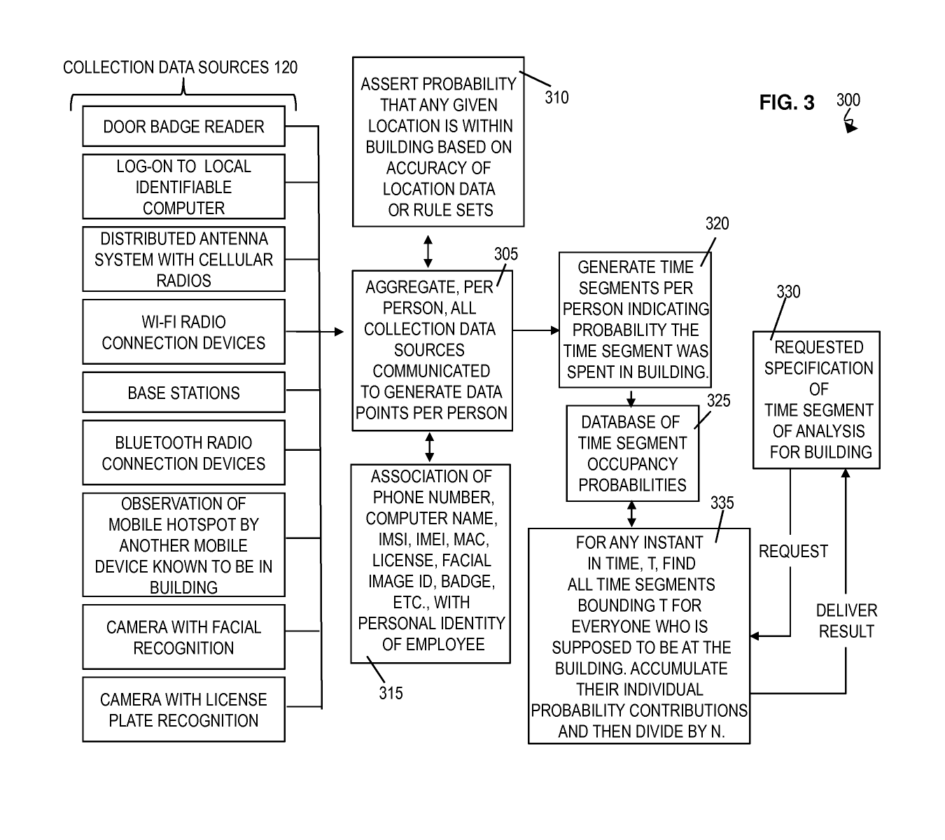

FIG. 3 illustrates a flow chart for determining the occupancy of the building according to an embodiment;

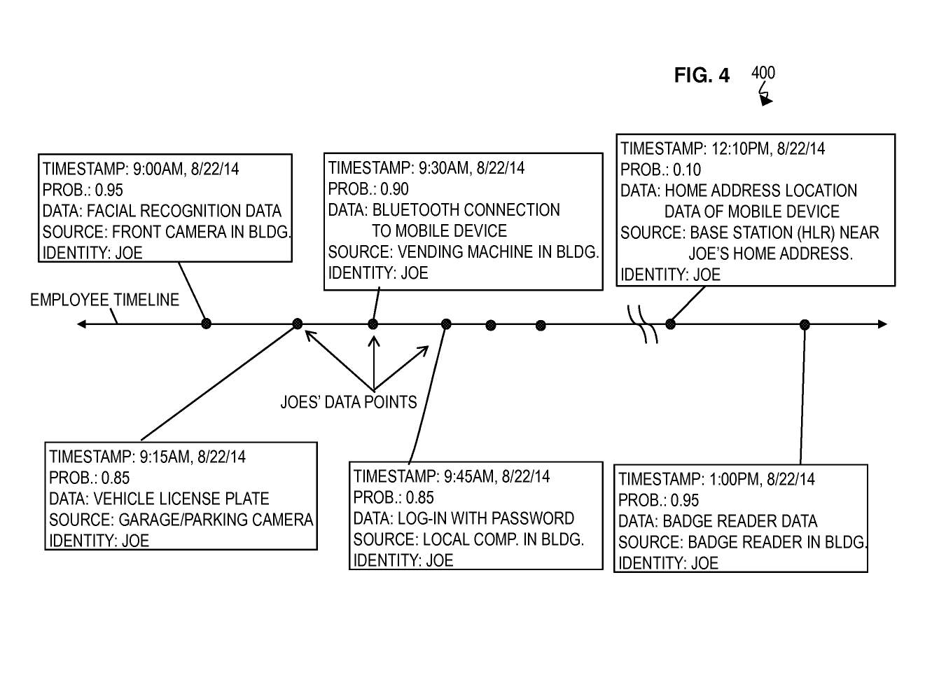

FIG. 4 illustrates an example snapshot timeline for a given potential occupant showing data points according to an embodiment;

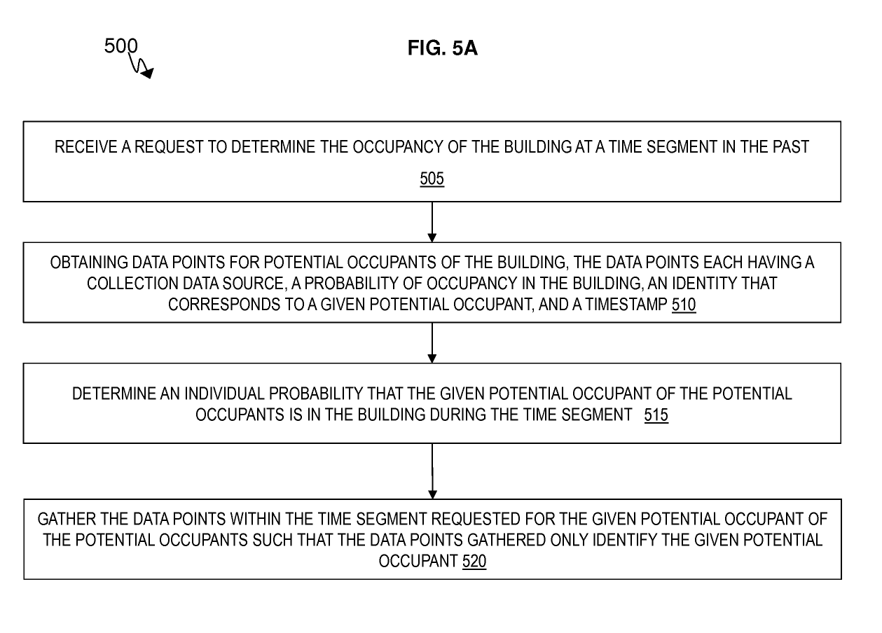

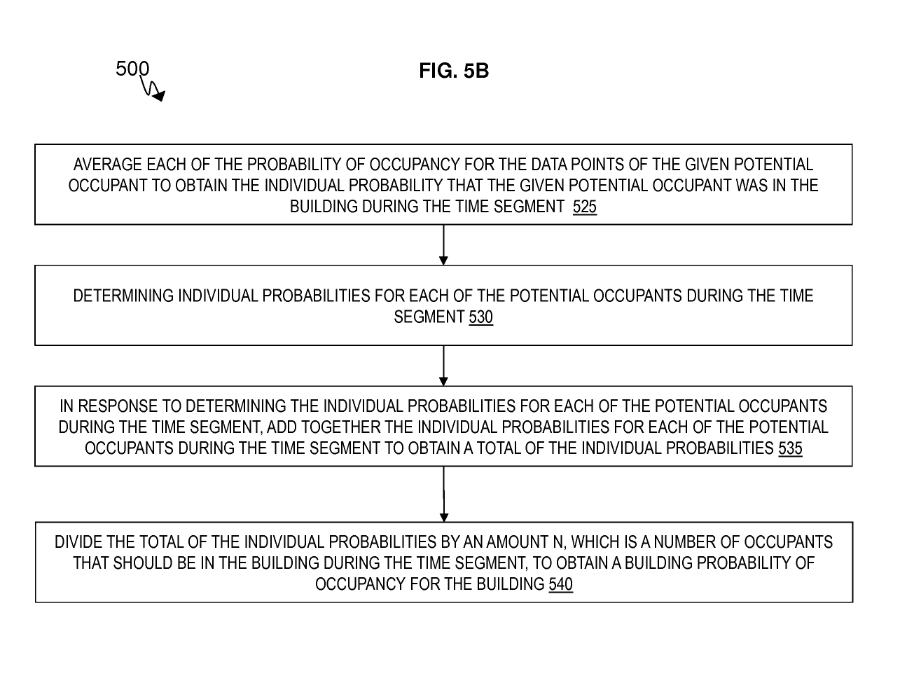

FIGS. 5A and 5B illustrate a flow chart of a method for determining occupancy of the building by software application of the computer system according to an embodiment; and

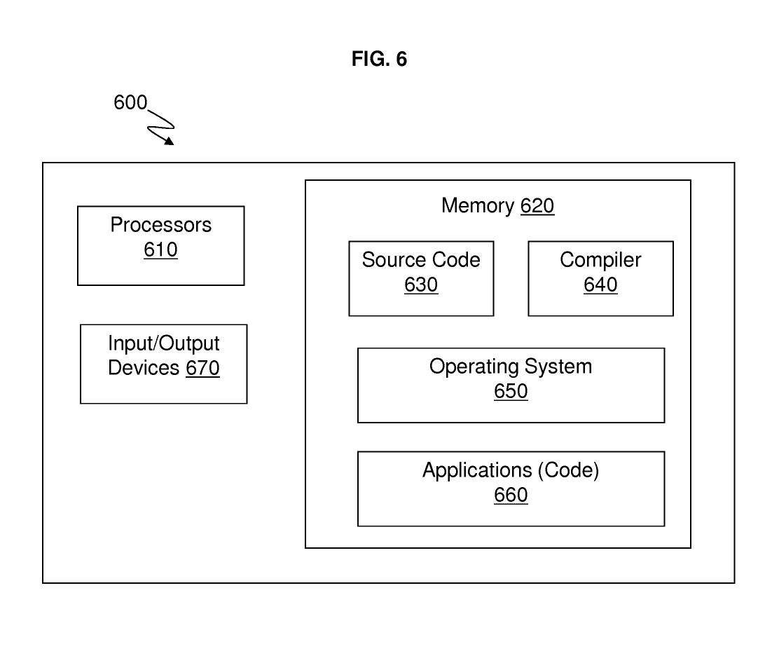

FIG. 6 illustrates an example of a computer having capabilities and features which may be included and/or incorporated in exemplary embodiments.

The detailed description explains the exemplary embodiments, together with advantages and features, by way of example with reference to the drawings.

### DETAILED DESCRIPTION OF DRAWINGS

Embodiments are described whereby businesses are able to accurately assess the occupancy levels of their owned and/or leased facilities. Embodiments allow businesses to fully understand the varying percentages of their personnel (i.e., employees, person, individual, etc.) showing up at various facilities on different days and different times of day. This allows major corporations to better manage their owned and/or leased facilities. Considering the amount of money all businesses pay for work spaces, this may be a significant opportunity for expense optimization.

A large business entity or company, such as AT&T®, may be an example of a company that is trying to determine which facilities to close or reduce to control expenses. The terms building and facility may be utilized interchangeably. Embodiments are able to utilize Big Data Analytics to provide insights into this problem.

One might think it would be trivial to know which of your employees is at work. However, just monitoring the badge reader does not work because many people simply walk through the door behind another person, even if rules say not to. Looking at computer activity does not always work because many job types do not require people to consistently log onto a computer. Location data are also insufficient because no method of locating can accurately report where everyone is all of the time, and not all employees will have a mobile phone to locate. No single method of figuring out who is at work is ideal or even particularly good with the consequence that building owners and lessors may not be able to accurately assess occupancy without sending people to walk around a building and find everyone. Even then, this would be a single snapshot in time and would not provide time-based occupancy behavior. Further, having people walk around to find employees is expensive.

According to embodiments, this issue may be addressed by using multiple systems (e.g., multiple collection data sources). FIG. 1 illustrates a system 10 for determining building occupancy from different collection data sources according to an embodiment.

The system 10 includes multiple collection data sources 120, which are individually represented as collection data sources 120A through 120Z. Each of the collection data sources 120 is a physical computing and/or electric device that is configured to collect data that is utilized to determine the presence of a person in a building 200 (e.g., geofenced building) and/or away from the building 200 as shown in FIG. 2. Note that the terms person, individual, potential occupant, occupant, and employee are used interchangeably to represent someone who is supposed to be in the building 200. In this case, it is assumed that the occupants of the building 200 are the employees of the building. There are N amount of total/maximum employees who are supposed to occupy the building 200, during e.g., work hours. A computer system 100 includes one or more software applications 105 configured to determine the occupancy of the building for any time segment. A time segment is a period of time in the past for which the occupancy rate of the building 200 is to be determined according to embodiments. The time period in the past may be 1 hour, 2 hours, 3 hours, 4 hours, 6 hours, 7 hours, 8 hours, etc. Larger time periods may be selected for the time segment as desired.

The collection data sources 120 provide their respective data to the computer system 100. The computer system 100 may pull and/or request the data of the collection data sources 120. Also, the collection data sources 120 may push the collected data to the computer system 100. The computer system 100 may be connected to the collection data sources 120 over a wired and/or wireless connection. In one case, the computer system 100 may be connected to one or more collection data sources 120 over a network 130. The computer system 100 is configured to address the problem of what is the occupancy in the building by utilizing multiple collection data sources 120 for “presence” data collection in parallel for each of the employees in the building 200, employees that should be in the building 200, and/or employees expected to be in the building 200.

The computer system 100 includes processors 21 for executing instructions, user interfaces 22 (such as keyboards, touch screens, mouse, microphone, camera, etc.) for interfacing with the computer system 100, network interfaces 23 for connecting to wired connections and wireless connections (with a transceiver) such as network 130, and display 24 for displaying information to the user.

The computer system 100 includes memory 30. The memory 30 may include one or more building occupancy software applications 105. The building occupancy software application 105 is configured to: receive collected data from the collection data sources 120, receive collected data from a server 205 (which can be considered a collection data source 120) in the building 200 shown in FIG. 2, delineate each piece of collected data as a data point for an individual employee which may include associating each piece of collected data with the identity of the employee, determine probability of occupancy in the building 200 per person for a given time segment based on the collected data, aggregate the probability of occupancy for each of the employees (N total of employees) who are supposed to be in the building 200 for the given time segment to obtain a total/aggregated probability of occupancy for all of the employees that are supposed to be in the building 200, and determine the probability of occupancy for the building at the given time segment by dividing the total/aggregated probability of occupancy for the total employees by N amount of employees that are supposed to be in the building 200.

Once the building occupancy software application 105 receives the collected data from the multiple collected data sources 120 (including server 205), the building occupancy software application 105 utilizes one or more association databases 135 to associate/link each piece of data to the particular employee that the piece of data belongs to the employee, and the combination of the piece of data and identity of the employee is a data point. Each data point has a timestamp associated with the data point, and the timestamp is the instant in time in which the piece of data was originally collected by the collection data source 120 (and/or server 205). For each data point generated by the software application 105, the software application 105 associates a probability according to a probability rule set 145. The probability given to the data point is based on the type of piece of data that has been collected. For example, when the piece of data is for a facial image (taken by a camera collection data source 120 in the building 200) that identifies an employee, the probability rule set 145 may give this data point (type of piece of data) a 0.99 (99%) probability of occupancy in the building 200 (for the particular employee). The probability rule set 145 contains the probability of occupancy for each type of piece of data collected by each collection data source 120, and the operator of the computer system 100 can change the probabilities as needed. Now, each data point includes and/or is associated with a timestamp in which the piece of data was collected by the collection data source 120, identification of the particular employee (e.g., Joe), what type of piece of data was collected (e.g., badge reader, facial image, vehicle license plate, Bluetooth connection, Wi-Fi connection, mobile location data, computer log-in, etc.), and a probability of occupancy in the building 200 for the employee. All of the data points for each respective employee are stored in a data points database 140 to be available for use by the software application 105. In one case, each employee of the company who is supposed to be in the building 200 has his own data points file 150. A data points file 150 has all the data points generated for an individual employee to date, and each individual employee has his own data point file 150.

There are a variety of collection data sources 120 that can collect data on an individual person. Some of the collection data sources 120 may be electronic devices, such as computing processing devices comprising hardware and/or software, in the building 200, while other collection data sources 120 may be electronic devices outside of the building 200. The collection data sources 120 (electronic devices) may be sensors that determine the presence of an employee in the building 200 and/or away from the building 200.

Various examples of the electronic devices for the collection data sources 120 are provided below. The collection data sources 120 include door badge readers required to access offices in the building 200. For instance, assume that there is a set of employees who are assigned work spaces at a facility which is building 200. On any given day and during any given time interval (i.e., time segment), the computer system 100 is configured to know (e.g., determine) which subset of these employees is present. Entry at a door with a badge reader (e.g., collection data source 120A) may imply the person will be present for a period of time, but if the person arrives in the morning, leaves for lunch, and does not re-enter and re-badge, then one would not know if the person actually returned to work (i.e., returned to the building 200). Nonetheless, badge readers (e.g., collection data source 120A) are one component of the aggregated data/information sources and feeds into the computer system 100 programmed for this purpose. Accordingly, the computer system 100 generates a data point for the collected data identifying the employee (e.g., Joe) by his badge information.

In the building 200, the collection data sources 120 may include locally identifiable computers which are also referred to as workstations and local computers. Persistent and/or even new connectivity of a local computer (e.g., collection data source 120B) to an Ethernet port demonstrates only the machine is present. Sometimes, local computers may be utilized by different individuals. Therefore, logged-on activity, using a username and password, is a far better indicator of presence of the logged-on person in the building 200. When the computer system 100 recognizes that a specific person is logged onto a network (in the building 200) from a local computer (e.g., collection data source 120B) that is known to be connected at a particular facility/building 200 by the Internet protocol (IP) address of the local computer (collection data source 120B), then the computer system 100 has compelling evidence of presence for the employee in the building 200. Accordingly, the computer system 100 generates a data point for the collected data identifying the employee (e.g., Joe) by log-in username and password to a local computer. This set of “present” users may be stored in a network server 205 in the building 200, and this set of present users/employees is also sent to the computer system 120.

In the building 200, the collection data sources 120 may include one or more in-building cellular radio (antenna) systems that connect to the mobile devices 210 of the employees. As utilized by the computer system 100, mobile location data of the mobile devices 210 of the employees can also be useful in determining which employees are occupying the building 200. The mobile devices 210 include cellphones, tablets, wearable devices (such as electronic watches, electronic glasses), and laptops. The computer system 100 knows/stores the individual phone numbers of employees in an association database 135, and uses the collected data of the in-building wireless radio system (collection data source 120) to which the mobile devices 210 connect. The computer system 120 is configured to ascertain with good probability that the employees connected to the in-building wireless radio system (collection data source 120) are present at that facility/building 200. The in-building cellular radio system can be a distributed antenna system with cellular radios (e.g., collection data sources 120C) that provide cellular network connection through a mobile network operator such as AT&T®, Sprint®, T-Mobile®, Verizon®, etc., where prior authorization has been consented to by the employees and prearranged with the mobile network operator. In one case, the entity of the building 200 may be a mobile network operator, such as AT&T®. Also, the in-building cellular radio system may be distributed wireless access points (e.g., collection data sources 120D) which are also referred to as Wi-Fi access points (provided by the building 200).

Regardless of whether the in-building cellular radio system is the distributed antenna system with cellular radios (e.g., collection data sources 120C) and/or the wireless access points (e.g., collection data sources 120D), when the computer system 100 observes the employees' mobile devices 210 connected to these radios (the distributed antenna system with cellular radios (e.g., collection data sources 120C) and/or the wireless access points (e.g., collection data sources 120D)), the computer system 100 can claim presence (in building 200) for these employees. Accordingly, the computer system 100 generates a data point for the collected data identifying the employee (e.g., Joe) by his mobile device 210 being connected to the distributed antenna system with cellular radios and/or to the wireless access point.

Moreover, Wi-Fi access points (e.g., collection data sources 120D) may “sniff” mobile beacons (i.e., mobile devices 210) in the building 200, which means that a connection need not be established to determine presence of the mobile devices 210.

The computer system 100 may also use other location methods such as GPS to confidently claim a person is at the facility. The employees or workers generally have a different physical location for their work address versus their home address. In most suburban or urban areas, their home and work locations (via mobile devices 210) are served by different base stations (e.g., collection data sources 120E) of a mobile network operator/carrier (AT&T®, Sprint®, T-Mobile®, Verizon®, etc.), and these base stations connected to cellphone towers are outside of the building 200. As noted above, prior authorization has been consented to by the employees and prearranged with the mobile network operators, such that the computer system 100 can request and access this mobile location data of employees. In one case, the mobile devices 210 may be been issued by the company having employees at the building 200. The computer system 100 stores the work and home locations of the employees in the association database 135, and the computer system 100 may use propagation modeling or empirical measurements of radio frequency (RF) coverage to determine if each employee (mobile device 210) is served from different base stations (e.g., collection data sources 120E). When an employee's mobile device 210 is served by different base stations (e.g., collection data sources 120E), the computer system 100 is configured to utilize the observation of such a person's mobile device 210 connected to a radio at the base station (collection data source 120E) which serves the work location (of the building 200) as a proxy for claiming presence so long as the computer system 100 determines that the observation has some reasonable degree of persistence which obviates the potential that the employee has simply driven past the work location. For instance, if computer system 100 determines that the mobile device 210 is connected to a tower of the base station (collection data source 120E) near the work location several times throughout the day except perhaps during lunch, the computer system 100 is configured to claim the person has been at work. Accordingly, the computer system 100 generates a data point for the collected data identifying the employee (e.g., Joe) by his mobile location data from a base station.

In the building 200, the collection data sources 120 may include one or more Bluetooth radio connection devices (e.g., collection data sources 120F) provided by the employer of the building 200. In one case, the Bluetooth radio connection devices (e.g., collection data sources 120F) may be vending machines that allow an employee to pay for snacks by connecting with his mobile device 210, and the employee can be presently or later charged the amount of the snacks. Each mobile device 210 that connects to the Bluetooth radio connection device (e.g., collection data source 120F) can be uniquely identified. The employee's information is sent from the Bluetooth radio connection device (e.g., collection data source 120F) to the computer system 100. Accordingly, the computer system 100 generates a data point for the collected data identifying the employee (e.g., Joe) by his identified mobile device 210 using a Bluetooth radio connection.

In the building 200, when a mobile hotspot generated by a mobile device 210 is observed/detected by another mobile device 210 of an employee known to be in the building 200, the collection data sources 120 may include the other mobile device 210 (e.g., collection data source 120G) of an employees (known to be in the building 200 by the computer system 100) that observed/detected the mobile hotspot. This occurs when the employee's mobile device 210 is utilized/detected as a hotspot by the other employee's mobile device 210 (known to be in the building 200 by the computer system 100), and mobile device 210 of the other employee who detected the hotspot sends the mobile hotspot information (generated by the hotspot mobile device 210) to the computer system 100. Assume that the first employee has his mobile device 210 operating as a hotspot and a second employee is connected to the communication network of the building 200 via the distributed antenna system with cellular radios (e.g., collection data sources 120C) and/or the wireless access points (e.g., collection data sources 120D). The second employee with his own mobile device 210 detects the hotspot created by the first employee's mobile device 210. By this detection/observation of the mobile hotspot created by the mobile device 210 of the first employee, the computer system 100 can access/detect the mobile device information of the first employee generating the mobile hotspot through the second employee's mobile device 210 (known to be in the building 200). Accordingly, the computer system 100 generates a data point for the collected data identifying the employee (e.g., Joe) as the employee generating the mobile hotspot.

In and/or around the building 200, the collection data sources 120 may include one or more cameras (e.g., collection data sources 120H) that include facial recognition software and/or access facial recognition software, and the facial image and identified employee are sent the computer system 100. In one case, the facial recognition software may be included in the server 205, where the facial recognition software works in concert with the cameras to determine the identity of each employee whose facial image has been captured by the cameras (e.g., collection data sources 120H). The identity of each employee (image) is sent to the computer system 100. Note that images of the employees are stored in advance in the association database 135, such that association of each employee facial image can be matched to respective employees (e.g., by the computer system 100 and/or the server 205). Accordingly, the computer system 100 generates a data point for the collected data identifying the employee (e.g., Joe) with facial image data.

In the parking lot and parking garage of the building 200, the collection data sources 120 may include one or more cameras (e.g., collection data sources 120I) that include vehicle license plate recognition software and/or access license plate recognition software, and the vehicle license plate and identified employee are sent to the computer 100. In one case, the license plate recognition software may be included in the server 205, where the license plate recognition works in concert with the cameras to determine the identity of each employee vehicle license plate whose image has been captured by the cameras. The cameras (e.g., collection data sources 120I) may be attached to the building 200 and lamp posts in the parking lot. Also, rovers (such as security personnel with cameras or a mechanical robot) may patrol the parking lot of the building 200 and take images of the vehicle license plates in the parking lot. The identity of each employee license plate is sent to the computer system 100. Note that vehicle license plate information of the employees are stored in advance in the association database 135, such that association of each vehicle license plate can be matched to respective employees (e.g., by the computer system 100 and/or the server 205). Accordingly, the computer system 100 generates a data point for the collected data identifying the employee (e.g., Joe) by his vehicle license plate.

Now, all of the data has been collected from the collection data sources 120, and the collected data has been processed as needed to be associated with respective employees (e.g., by the computer system 100 and/or the server 205). Collectively, the computer system 100 is configured to determine that of the N persons who are designated to work at the building and during the time interval of interest (i.e., the time segment), Y of them were observed using method A, Y′ were observed using method B, Y″ were observed using method C, and so forth. Many of these observations by the respective collection data sources 120 may demonstrate repeats for the same individuals, but the count of unique individuals, divided by N persons, and then multiplied by 100 would be the percentage of occupancy for the building 200 during the time segment (as determined by the computer system 100).

Now turning to FIG. 3, a flow chart 300 is provided for determining the occupancy of the building 200 according to an embodiment. The building occupancy software application 105 in the computer system 100 is configured to receive various collected data from the collection data sources 120, and in some cases the server 205 may be a collection data source 120. The collected data can be pushed from the collection data sources 120 to the computer system 100 and can be pulled by the computer system 100 from the collection data sources 120.

At block 305, the building occupancy software application 105 in computer system 100 is configured to aggregate, per person, all collected data of collection data sources 120 communicated over wired, wireless, and IP paths. From the collected data, the building occupancy software application 105 in computer system 100 creates data points, per person, for each piece of collected data from collection data sources 120. Each data point has a timestamp of when the piece of collected data was collected and/or captured by the particular collection data source 120. Each piece of collected data has a one-to-one relationship with a single data point of an employee. Assume that an employee Joe now has a data point from a piece of collected data, and the data point has a timestamp indicating the instant at which the piece of data was collected. In one case, the data point may initially have the employee identification/name Joe because the piece of collected data came from a badge reader collection data source 120 in which the identification of Joe was provided as soon as his badge was scanned. In another case, a data point may not have the identification of Joe such as when the camera collection data source 120 captures facial image data of Joe but Joe has yet to be identified as the employee in the facial image. Joe may have numerous data points created over the course of a work day, e.g., 8 hours, from different instances in time when collection data sources 120 collect pieces of data.

At block 315, for each data point, the building occupancy software application 105 of computer system 100 is configured to associate/match phone number, computer name, international mobile subscriber identity (IMSI, which is used to identify the user (mobile device/phone) of a cellular network), international mobile station equipment identity (IMEI, which is a number to identify a mobile device/phone), media access control address (MAC address, is a unique identifier assigned to network interfaces for communications), license plate number, facial image identity, badge identity, etc., with the personal identity of the employee by using the personal identity association information in the association database 135. The building occupancy software application 105 may have a data point associated with a piece of collected data (such as a facial image) and timestamp. The software application 105 is configured to match the piece of collected data (facial image) with personal identity association information in the association information database 135, in order to identify that the piece of collected data corresponds to employee Joe. Accordingly, an employee, Joe, has a data point with a timestamp, associated piece of collected data (facial image), collection data source 120 (e.g., camera at entrance of building 200), and identity.

At block 310, the building occupancy software application 105 of computer system 100 is configured to assert probability that any given location at which the collected data was collected within the geofenced building 200 based on accuracy of location data and/or based on rule sets in the probability rule set 145. There may be many collection data sources 120 that are within the geofenced building 200, and the collected data from these collection data sources 120 can have a higher probability that the location, corresponding to the location of the employee, is within the geofenced building 200 according to the probability rule set 145; accordingly, each data point has its own probability of occupancy for the identified employee (e.g., Joe) according to the piece of collected data from a collection data source 120. A particular data point attached to a respective piece of collected data from a collection data source 120 in the geofenced building is assigned a higher probability of occupancy (such as 0.95-1.0 (90-100%) probability of occupancy) than a data point corresponding to a piece of collected data outside of the geofenced building 200. For example, collected data from a door badge reader (reading badge of Joe) at building 200 entrance, collected data from a Wi-Fi radio connection (in building 200) to mobile device 210 (uniquely identified as Joe), collected data from log-on to uniquely identifiable local computer in building 200 (where username and password uniquely identify Joe), collected data from Bluetooth radio connection (in building 200) to mobile device 210 (uniquely identified as Joe), collected data observing the mobile hotspot generated by mobile device 210 (uniquely identified as Joe) by another mobile device 210 (known to be in the building 200), collected data from camera (in the building 200) capturing facial image (identified as Joe), and collected data from camera (in the building 200 garage) capturing vehicle license plate (identified as Joe) are each a distinct data point with a high probability of occupancy (e.g., 0.95-1.0 (or 95-100%) for Joe. The building occupancy software application 105 recognizes the collection data source of collected data for each data point with the probability stored in the probability rule set 145 (for that type of collection data source 120), and the building occupancy software application 105 applies a probability to each data point according to the origin (location) at which the collected data was captured.

On the other hand, assume that collected data is from a base station near Joe's home which is not at/near the building 200 (e.g., home is away from the building 200 by a predefined distance), such as 20 miles away from work/building 200. Along with Joe's present location, this base station may provide the mobile phone number, IMSI, and/or IMEI of mobile device 210 to be matched (by software application 105) against the same corresponding information in the association database 135, in order to identify Joe's mobile device 210 (now at the home address). Also, the base station via a home location register may send Joe's name and home location address to the software application 105 (such that the software application 105 does not have to perform the matching and association). Since this data point of where the piece of collected data is Joe's home address corresponding to Joe's mobile device, the software application 105 checks the probability rule set 145 to determine that the probability of Joe being at work for this instant in time is very low (0.0-0.15 (0-15%)) because Joe's home address is 20 miles from the building 200 address. Suppose someone purposely and/or mistakenly swiped in with Joe's badge within 5 minutes of the timestamp for the data point associated with Joe's home address. For a time segment (9:00 am to 10:00 am which is 1 hour on date J) that includes both of these data points (data point for Joe badge swipe (e.g., 0.95) and data point for home address (e.g., 0.15), the probability of the data points would be averaged to determine the probability of occupancy for Joe during the given time segment: (0.15+0.95)/2=0.55, which is 55% (when multiplied by 100). For the two data points, there is a 0.55 probability of occupancy (or 55% probability of occupancy) that Joe was actually in the building 200 for the given time segment (9:00 am to 10:00 am).

There can numerous data points determined for each potential occupant, such as Joe, by building occupancy software application 105, and the building occupancy software application 105 stores the data points in the data points database 140. At block 320, the software application 105 is configured to generate time segments, per person, indicating the probability the time segment was spent at the geofenced building 200, and the probability of occupancy per time segment (per person) is the average probability of the data points having a timestamp within the time segment. For the time segment 9:00-10:00 am for Joe, Joe's probability of occupancy is 0.55 (55%).

At block 325, the building occupancy software application 105 of computer system 100 is configured to store (in advance) the time segment occupancy probabilities, per person, in a time segment database 155. For all data points previously stored per person, the time segment database 155 stores all past time segments with probability of occupancy per time segment per person. For example, for any date in the past, Joe has a probability of occupancy for a first time segment (e.g., 8:00-9:00 am), second time segment (e.g., 9:00-10:00 am), a third time segment (11:00 am-12:00 pm), a fourth time segment (1:00-2:00 pm), and so forth. Having time segments (per person) pre-calculated from that person's stored data points by the software application 105 allows for a quicker response when a request is made. Note that the time segments are not limited to 1 hour time periods, and can be any period of time of the day. Also, two or more time segments for a person can be averaged to provide the probability of occupancy for the corresponding period of the two or more time segments. As such, the individual probability for times segments 9:00-10:0 am and 10:00-11:00 am may be averaged for a probability of occupancy of, e.g., 0.80 (80%). In this example, the software application 105 can determine that Joe had an 0.80 probability of occupancy (80%) in the building 200 for the time segment 9:00-11:00 am. Accordingly, time segments are prepared in advance for each employee before a request is made, such that the particular time segment, for an individual employee, a particular group of employees, and/or all employees N, can be provided on request from the time segments database 155.

At block 330, the building occupancy software application 105 of computer system 100 is configured to receive a request specifying time segment analysis for a particular building (i.e., building 200).

At block 335, the building occupancy software application 105 of computer system 100 is configured to for any instant in time, T, find all time segments bounding T for everyone who is supposed to be at the building 200; and the building occupancy software application 105 is configured to accumulate their individual probability contributions and divide by N. N is the list of people who are supposed to be at the building 200. For example, T may be a time period 9:00-11:00 am on a certain date. There are two options for how building occupancy software application 105 of computer system 100 can determine the probability of occupancy for the time period (T) 9:00-11:00 am for all employees N. For ease of understanding assume that there are N=3 employees, which means that there are a total of 3 employees who are supposed to be in the building 200. As an example scenario, the 3 employees are Joe, Mary, and Bob.

As one option, the building occupancy software application 105 of computer system 100 is configured to obtain Joe's time segment(s) corresponding to 9:00-11:00 am for Joe, Mary's time segment(s) corresponding to 9:00-11:00 am for Mary, and Bob's time segment(s) corresponding to 9:00-11:00 am for Bob. If each time segment was (originally) stored in 2 hour blocks in the time segment database 155, the probability of occupancy for each 9:00-11:00 am time segment for Joe (0.80), Mary (0.90), and Bob (0.95) can be added together (0.80+0.90+0.95=2.65) and then divided by 3 (2.65/3=0.883) where N is 3 in this case. The probability of occupancy of 0.883 (88.3%) for the building 200 at the requested 9:00-11:00 am time segment is delivered/displayed by the software application 105. If the time segment for Joe, Mary, and Bob are originally stored in 1 hour blocks (such as 8:00-9:00 am and 9:00-10:00 am) in the time segment database 155, then the software application 105 is configured to average the probabilities for each 1 hour time segment to obtain probabilities for 2 hour time segments (from 9:00-11:00 am) for Joe, Mary, and Bob. Now the software application 105 can proceed (average) as above using the two hour time segments to obtain the probability of occupancy of 0.883 (88.3%) for the requested 9:00-11:00 am time segment for all employees who are supposed to be in the building 200.

As a second option, suppose that the time segments from 9:00-11:00 am may not have been calculated yet for Joe, Mary, and Bob, and the building occupancy software application 105 has to retrieve all the data points from the data points database 140 that are within the time period from 9:00-11:00 am on the requested date for Joe, Mary, and Bob. Each data point has a probability of occupancy, a timestamp, an associated piece of data (e.g., facial image, badge reader scan, log-in with username and password), collection data source 120, and an identity of the potential occupant (e.g., Joe, Mary, or Bob in this case). Once all the data points within the requested time segment 9:00-11:00 am are gathered for Joe, the software application 105 is configured to average the probabilities for Joe's data points to obtain a probability of occupancy of 0.80 for the 9:00-11:00 am time segment. Similarly, once all the data points within the requested time segment 9:00-11:00 am are gathered for Mary, the software application 105 is configured to average the probabilities for Mary's data points to obtain a probability of occupancy of 0.90 for the 9:00-11:00 am time segment. Again, once all the data points within the requested time segment 9:00-11:00 am are gathered for Bob, the software application 105 is configured to average the probabilities for Bob's data points to obtain a probability of occupancy of 0.95 for the 9:00-11:00 am time segment. The probability of occupancy for each 9:00-11:00 am time segment for Joe (0.80), Mary (0.90), and Bob (0.95) are added together (0.80+0.90+0.95=2.65) and then divided by 3 (2.65/3=0.883) to obtain the probability of occupancy of 0.883 (88.3%) for the requested 9:00-11:00 am time segment for the building 200.

FIG. 4 illustrates an example snapshot timeline 400 for potential occupant Joe showing data points from 9:00 am-1:00 pm according to an embodiment. The timeline may be stored in Joe's data points file 150 in the data points database 140, along with the other data points for Joe. As stored in the data points database 140 (e.g., data points file 150 for employee Joe), each data point has a timestamp, probability of occupancy, piece of collected data (type a data), collection data source 120, and identity (i.e., Joe). Analogously, each employee has his own timeline of data points corresponding to the collected data for that particular employee (e.g., Mary, Bob).

Each operator of the computer system 100 can set probabilities of occupancy in the probability rule set 145 for each type of collection data source 120 and/or each type of collected data. This allows probability of occupancy rules in the probability rule set 145 to be applied by the software application 105 to each data point for the potential occupants.

Now turning to FIGS. 5A and 5B, a flow chart 500 is provided of a method for determining occupancy of the building 200 by software application 105 of the computer system 100 according to an embodiment.

At block 505, the computer system 100 is configured to receive a request (e.g., from a computer 100 and/or from the user of the computer system 100) to determine the occupancy of the building 200 at a time segment in the past. The request may be input by the operator of the computer system 100 and/or received from user.

At block 510, the computer system 100 is configured to obtain data points for potential occupants of the building 200, in which the data points each have a collection data source 120, a piece of collected data (facial image), a probability of occupancy in the building 200, an identity that corresponds to a given potential occupant (e.g., Joe, Mary, or Bob), and a timestamp (date and time the data was collected). FIG. 4 shows example data points for Joe take from 9:00 am to 1:00 pm.

At block 515, the computer system 100 is configured to determine an individual probability that the given potential occupant of the potential occupants is in the building during the time segment by: gathering the data points within the time segment requested for the given potential occupant of the potential occupants such that the data points gathered only identify the given potential occupant (at block 520); averaging each of the probability of occupancy for the data points of the given potential occupant to obtain the individual probability that the given potential occupant was in the building 200 during the time segment (at block 525); and determining individual probabilities for each of the potential occupants during the time segment (at block 530). For example, from the data points within the time segment, the computer system 100 can determine the individual probability of occupancy during the time segment as 0.80 for Joe, 0.90 for Mary, and 0.95 for Bob.

At block 535, the computer system 100 is configured to, in response to determining the individual probabilities for each of the potential occupants during the time segment (just as described for the given potential occupant), add together the individual probabilities for each of the potential occupants during the time segment to obtain a total of the individual probabilities. For example, the probability of occupancy for each 9:00-11:00 am time segment for Joe (0.80), Mary (0.90), and Bob (0.95) is added together (0.80+0.90+0.95=2.65).

At block 540, the computer system 100 is configured to divide the total of the individual probabilities by an amount N, which is a number of occupants that should be in the building 200 during the time segment, to obtain a building probability of occupancy for the building 200. For example, the total of the individual probabilities (2.65) is divided by 3 (2.65/3=0.883) to obtain the probability of occupancy of 0.883 (88.3%) for the requested 9:00-11:00 am time segment for the building 200.

The computer system 100 is configured to associate the probability of occupancy for each data point based on the collection data source 120 and a type of collected data, and the data points having the collection data sources 120 at the building 200 have a higher probability of occupancy than the data points having the collection data sources located a predetermined distance away from the building. The predetermined distance may be X miles away, such as more than 10, 15, 20, 30 . . . 50 miles away.

The computer system 100 is configured to recognize that the individual probability for the given potential occupant (any employee, such as Joe, Mary, Bob) requires more than one data point during the time segment requested. When only the one data point is in the time segment requested, the time segment is automatically enlarged (by the computer system 100) to include an additional data point before or after the time segment requested. In this case, the computer system 100 may enlarge the time segment in 30 minute intervals before and/or after the requested time segment in order to include at least one additional data point for the potential occupant and continues enlarging the time segment by 30 minutes until at least one additional data point is found. If the enlargement is needed for (only) one particular employee (e.g., Joe), this enlargement would occur for each of the other potential occupants (May and Bob) such that the time segment is the same for each employee, and the enlarged time segment is reported back to the requesting user. For example, if the original time segment was 12:00-12:30 pm in FIG. 4, the computer system 100 may enlarge the time segment 30 minutes to include the data point at 1:00 pm for Joe. The individual probability determined for the given potential occupant is a likelihood that the given potential occupant was present in the building 200 during the time segment requested.

The data points specific to each of the potential occupants (such as Joe's data points in FIG. 4, and similar data points for Mary and Joe) are respectively stored in an individual file for the potential occupants, such that the data points for the potential occupant are identifiable.

The different time segments for each of the potential occupants are created in advance (e.g., pre-stored in time segments database 155) in anticipation for the time segment requested (and other time segment requests for different time periods). Each of the different time segments has a time segment probability of occupancy (such as, 0.90, 0.85, 0.15, etc.). Each of the different time segments has a corresponding beginning time and ending time (i.e., a timestamp) on respective dates. The time segment probability, for the different time segments, is generated from the data points within the corresponding beginning time and ending time. A minimum block of time is required for each of the different time segments, such as 1 hour.

FIG. 6 illustrates an example of the computer 600 having capabilities, which may be included in exemplary embodiments. Various methods, procedures, circuits, elements, and techniques discussed herein may incorporate and/or utilize the capabilities of the computer 600. One or more of the capabilities of the computer 600 may be utilized to implement, to incorporate, to connect to, and/or to support any element discussed herein (as understood by one skilled in the art) in FIGS. 1-5. For example, the elements 100, 120, 130, 145, 160, 205 may incorporate any of the hardware and software features discussed in FIG. 6.

Generally, in terms of hardware architecture, the computer 600 may include one or more processors 610, computer readable storage memory 620, and one or more input and/or output (I/O) devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a data signal processor (DSP), or an auxiliary processor among several processors associated with the computer 600, and the processor 610 may be a semiconductor based microprocessor (in the form of a microchip) or a microprocessor.

The computer readable memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the computer readable memory 620 may include one or more separate programs, each of which comprises an ordered listing of executable instructions for implementing logical functions. The software in the memory 620 includes a suitable operating system (O/S) 650, compiler 640, source code 630, and one or more applications 660 of the exemplary embodiments. As illustrated, the application 660 comprises numerous functional components for implementing the features, processes, methods, functions, and operations of the exemplary embodiments. The application 660 of the computer 600 may represent numerous applications, agents, software components, modules, interfaces, controllers, etc., as discussed herein but the application 660 is not meant to be a limitation.

The operating system 650 may control the execution of other computer programs, and provides scheduling, input-output control, file and data management, memory management, and communication control and related services.

The application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as (a) an object oriented programming language, which has classes of data and methods, or (b) a procedure programming language, which has routines, subroutines, and/or functions.

The I/O devices 670 may include input devices (or peripherals) such as, for example but not limited to, a mouse, keyboard, scanner, microphone, camera, etc. Furthermore, the I/O devices 670 may also include output devices (or peripherals), for example but not limited to, a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or an intranet. The I/O devices 670 may be connected to and/or communicate with the processor 610 utilizing Bluetooth connections and cables (via, e.g., Universal Serial Bus (USB) ports, serial ports, parallel ports, FireWire, HDMI (High-Definition Multimedia Interface), etc.).

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software, it should be noted that the application 660 can be stored on virtually any computer readable storage medium for use by or in connection with any computer related system or method. The application 660 can be embodied in any computer-readable medium for use by or in connection with an instruction execution system, apparatus, server, or device, such as a computer-based system, processor-containing system, or other system that can fetch the instructions from the instruction execution system, apparatus, or device and execute the instructions.

In exemplary embodiments, where the application 660 is implemented in hardware, the application 660 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the exemplary embodiments can be in the form of processor-implemented processes and devices for practicing those processes, such as processor. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of the referenced item.

What is claimed is:

1. A method for determining occupancy of a building, the method comprising:
receiving a request to determine the occupancy of the building at a time segment in the past;
obtaining data points for potential occupants of the building, the data points each having a collection data source, a probability of occupancy in the building, an identity that corresponds to a given potential occupant, and a timestamp;
determining an individual probability that the given potential occupant of the potential occupants is in the building during the time segment by:
gathering the data points within the time segment requested for the given potential occupant of the potential occupants such that the data points gathered only identify the given potential occupant;
averaging each of the probability of occupancy for the data points of the given potential occupant to obtain the individual probability that the given potential occupant was in the building during the time segment;
determining individual probabilities for each of the potential occupants during the time segment;
in response to determining the individual probabilities for each of the potential occupants during the time segment, adding together the individual probabilities for each of the potential occupants during the time segment to obtain a total of the individual probabilities; and
dividing the total of the individual probabilities by an amount N, which is a number of occupants that should be in the building during the time segment, to obtain a building probability of occupancy for the building.

2. The method of claim 1, further comprising associating the probability of occupancy for each data point based on the collection data source and a type of collected data;
wherein the data points having collection data sources at the building have a higher probability of occupancy than the data points having the collection data sources located a predetermined distance away from the building.

3. The method of claim 2, wherein the individual probability for the given potential occupant requires more than one data point during the time segment requested;
wherein when only the one data point is in the time segment requested, the time segment is automatically enlarged to include an additional data point before or after the time segment requested; and
wherein the individual probability determined for the given potential occupant is a likelihood that the given potential occupant was present in the building during the time segment requested.

4. The method of claim 1, wherein the data points specific to each of the potential occupants are respectively stored in an individual file for the potential occupants, such that the data points for the given potential occupant are identifiable.

5. The method of claim 1, wherein different time segments for each of the potential occupants are created in advance in anticipation for the time segment requested.

6. The method of claim 5, wherein each of the different time segments has a time segment probability of occupancy.

7. The method of claim 5, wherein each of the different time segments has a corresponding beginning time and ending time;
wherein the time segment probability, for the different time segments, is generated from the data points within the corresponding beginning time and ending time.

8. The method of claim 7, wherein a minimum block of time is required for each of the different time segments.

9. An apparatus for determining occupancy of a building, the apparatus comprising:
a processor; and
memory comprising computer-executable instructions that, when executed by the processor, cause the processor to perform operations, the operations comprising:
receiving a request to determine the occupancy of the building at a time segment in the past;
obtaining data points for potential occupants of the building, the data points each having a collection data source, a probability of occupancy in the building, an identity that corresponds to a given potential occupant, and a timestamp;
determining an individual probability that the given potential occupant of the potential occupants is in the building during the time segment by:
gathering the data points within the time segment requested for the given potential occupant of the potential occupants such that the data points gathered only identify the given potential occupant;
averaging each of the probability of occupancy for the data points of the given potential occupant to obtain the individual probability that the given potential occupant was in the building during the time segment;
determining individual probabilities for each of the potential occupants during the time segment;
in response to determining the individual probabilities for each of the potential occupants during the time segment, adding together the individual probabilities for each of the potential occupants during the time segment to obtain a total of the individual probabilities; and
dividing the total of the individual probabilities by an amount N, which is a number of occupants that should be in the building during the time segment, to obtain a building probability of occupancy for the building.

10. The apparatus of claim 9, further comprising associating the probability of occupancy for each data point based on the collection data source and a type of collected data;
wherein the data points having collection data sources at the building have a higher probability of occupancy than the data points having the collection data sources located a predetermined distance away from the building.

11. The apparatus of claim 10, wherein the individual probability for the given potential occupant requires more than one data point during the time segment requested;
wherein when only the one data point is in the time segment requested, the time segment is automatically enlarged to include an additional data point before or after the time segment requested; and
wherein the individual probability determined for the given potential occupant is a likelihood that the given potential occupant was present in the building during the time segment requested.

12. The apparatus of claim 9, wherein the data points specific to each of the potential occupants are respectively stored in an individual file for the potential occupants, such that the data points for the given potential occupant are identifiable.

13. The apparatus of claim 9, wherein different time segments for each of the potential occupants are created in advance in anticipation for the time segment requested.

14. The apparatus of claim 13, wherein each of the different time segments has a time segment probability of occupancy.

15. The apparatus of claim 13, wherein each of the different time segments has a corresponding beginning time and ending time;
wherein the time segment probability, for the different time segments, is generated from the data points within the corresponding beginning time and ending time.

16. The apparatus of claim 14, wherein a minimum block of time is required for each of the different time segments.

17. A computer program product, tangibly embodied on a computer readable medium, for determining occupancy of a building, the computer program product including instructions that, when executed by a processor, cause the processor to perform operations comprising:
receiving a request to determine the occupancy of the building at a time segment in the past;
obtaining data points for potential occupants of the building, the data points each having a collection data source, a probability of occupancy in the building, an identity that corresponds to a given potential occupant, and a timestamp;
determining an individual probability that the given potential occupant of the potential occupants is in the building during the time segment by:
gathering the data points within the time segment requested for the given potential occupant of the potential occupants such that the data points gathered only identify the given potential occupant;
averaging each of the probability of occupancy for the data points of the given potential occupant to obtain the individual probability that the given potential occupant was in the building during the time segment;
determining individual probabilities for each of the potential occupants during the time segment;
in response to determining the individual probabilities for each of the potential occupants during the time segment, adding together the individual probabilities for each of the potential occupants during the time segment to obtain a total of the individual probabilities; and
dividing the total of the individual probabilities by an amount N, which is a number of occupants that should be in the building during the time segment, to obtain a building probability of occupancy for the building.

18. The computer program product of claim 17, further comprising associating the probability of occupancy for each data point based on the collection data source and a type of collected data;
wherein the data points having collection data sources at the building have a higher probability of occupancy than the data points having the collection data sources located a predetermined distance away from the building.

19. The computer program product of claim 18, wherein the individual probability for the given potential occupant requires more than one data point during the time segment requested;
wherein when only the one data point is in the time segment requested, the time segment is automatically enlarged to include an additional data point before or after the time segment requested; and
wherein the individual probability determined for the given potential occupant is a likelihood that the given potential occupant was present in the building during the time segment requested.

20. The computer program product of claim 17, wherein the data points specific to each of the potential occupants are respectively stored in an individual file for the potential occupants, such that the data points for the given potential occupant are identifiable.
